(19) United States
(12) Patent Application Publication
(10) Pub. No.: US 2006/0107073 A1
(43) Pub. Date: May 18, 2006

(54) System and method for equipment security cable lock interface

(75) Inventors: Bradford Eugene Lane, Durham, NC (US); John W. Polischak, Clayton, NC (US)

Correspondence Address: VANLEEUWEN & VANLEEUWEN, P.O. BOX 90609, AUSTIN, TX, 78709-0609, US

(73) Assignee: International Business Machines Corporation, Armonk, NY (US)

(21) Appl. No.: 10/988,033

(22) Filed: Nov. 12, 2004

(51) Int. Cl. G06F 12/14

(52) U.S. Cl. 713/194; 340/5.8; 70/58; 224/258

(57) ABSTRACT

A cable lock apparatus that is operated by the computer equipment that the apparatus is intended to protect, rather than by a key, is disclosed. According to a preferred embodiment of the invention, the cable lock is equipped with a hot-swappable computer interface, such as a Universal Serial Bus (USB) interface, for connecting to the computer. The user of the computer unlocks the cable lock by providing a password or other form of authentication to the computer. The computer transmits this authentication information, via the USB interface, to circuitry within the cable lock device, which validates the authentication information. If the authentication information validates properly, the cable lock device circuitry activates a motor or solenoid to mechanically release the cable lock.

### BACKGROUND OF THE INVENTION

1. Technical Field

The present invention is related generally to anti-theft devices for computer equipment. Specifically, the present invention is directed to a cable lock system that may be unlocked by a computer.

2. Description of the Related Art

As computer equipment has become smaller and increasingly portable, the problem of equipment theft has become a greater concern. A number of security devices exist in the art for preventing the theft of computer equipment. One particular type of device that is frequently used is a cable lock apparatus. U.S. Patent Grant MURRAY et al. (U.S. Pat. No. 5,502,989) 1996-4-2 provides examples of typical cable lock devices as exist in the art.

One common configuration for a cable lock device, as known in the art, is presented in FIG. 1. A device 100 to be protected from theft (in this case, a video display monitor) is outfitted with an aperture 102 that is adapted to allow a flexible cable 104 to be threaded through it. One end of cable 104 is terminated in a padlock 106; the other end is terminated in a mushroom-shaped terminal 108, which is adapted to be inserted into padlock 106. When terminal 108 is inserted into padlock 106, a pin, ring, or other retaining mechanism (not shown) engages with terminal 108 to prevent terminal 108 from being removed from padlock 106 unless a key 110 is inserted into padlock 106 and turned, in which case, the retaining mechanism is released. To use the device depicted in FIG. 1 for theft prevention, cable 104 is threaded through aperture 102 as well as some other aperture (not shown) that is attached to a fixed location (such as a wall or the surface of a counter or desk) before locking terminal 108 into padlock 106.

Another cable lock device that is commonly employed in conjunction with notebook computers and other highly portable devices is shown in FIG. 2. A device 200 to be protected (in this case, a computer keyboard) is outfitted with a built-in aperture (not visible in FIG. 2). Cable 202 is terminated on one end by a locking plug 204 (shown in greater detail in FIG. 3) that is adapted to be attached to device 200 through device 200's built-in aperture and locked/unlocked to/from device 200 through the use of a key inserted and turned within circular keyhole 206.

FIGS. 3, 4, and 5 illustrate the locking mechanism employed by plug 204. A rotatable elongate member 300 extends outward from plug 204. To attach plug 204 to device 200, one inserts member 300 through an elongate aperture 402 in an outer wall 400 of device 200, as shown in FIG. 4. Plug 204 is locked in place by inserting a key 500 into circular keyhole 206 and turning key 500 a quarter turn. This causes member 300 to also rotate a quarter turn to become generally perpendicular to the longitudinal axis of aperture 402, as shown in FIG. 5. When member 300 is perpendicular to the longitudinal axis of aperture 402, plug 204 may not be removed from wall 400 and is thus locked in place.

Returning now to FIG. 2, the other end of cable 202 is terminated in a loop 208. As suggested by FIG. 2, the preferred method of use of the device is for the plug-end of cable 202 to be threaded through loop 208 to make a larger loop. If cable 202 is also threaded to a aperture permanently affixed to a tabletop, wall, or other stationary surface (not shown), one will be physically prevented from removing device 200 from the immediate vicinity of that stationary surface.

While the devices shown in FIGS. 1-5 are, from a purely physical standpoint, highly effective in preventing equipment theft, their effectiveness as a theft-preventative can be limited in practice as the result of a number of factors. In particular, when a cable lock apparatus is used in conjunction with equipment that is intended to be portable (such as a notebook computer), the cable lock apparatus will, in general, be used to provide only temporary protection from theft at a particular location. For example, an employee-user who takes his or her notebook computer home from work may only utilize the cable lock while at work. This means that the user must make regular use of a key to unlock the cable lock before taking the equipment home.

In practice, this regular reliance on a physical key tends to lead to security compromises. Specifically, the need to use a key on a frequent basis requires that the user not lose or misplace the key, or else the cable lock cannot be unlocked and the equipment may not be removed when necessary. Rather than keeping up with a separate key, then, some users may, for the sake of convenience, leave the key in the keyhole of the cable lock or otherwise attach the key to the cable lock itself. In particular, a corporate user with a company-issued notebook computer may be required to utilize a cable lock at work, as company policy, but may be more motivated by convenience than by preventing theft of company-owned equipment. This practice of leaving the key in the lock, however, essentially defeats the purpose of the cable lock in the first place, and is an unacceptable security risk.

Thus, what is needed is a cable lock apparatus which prevents security compromises by user practices such as leaving the key in the lock. The present invention provides a solution to this and other problems, and offers other advantages over previous solutions.

### SUMMARY

Accordingly, a preferred embodiment of the present invention is directed to a cable lock apparatus that is operated by the computer equipment that the apparatus is intended to protect, rather than by a key. According to this preferred embodiment, the cable lock is equipped with a hot-swappable computer interface, such as a Universal Serial Bus (USB) interface, for connecting to the computer. The user of the computer unlocks the cable lock by providing a password or other form of authentication to the computer. The computer transmits this authentication information, via the USB interface, to circuitry within the cable lock device, which validates the authentication information. If the authentication information validates properly, the cable lock device circuitry activates a motor or solenoid to mechanically release the cable lock.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein

FIG. 1 is a diagram of a padlock-equipped cable lock device as known in the art;

FIG. 2 is a diagram of a plug-equipped cable lock device as known in the art;

FIG. 3 is a diagram illustrating the plug utilized in the cable lock device of FIG. 2 in greater detail;

FIGS. 4 and 5 illustrate steps in the insertion and locking of the cable lock device in FIG. 2 to a built-in aperture of a device to be protected;

FIG. 6 is a pictorial diagram providing an external view of a cable lock device in accordance with a preferred embodiment of the present invention;

FIG. 7 is a deployment diagram illustrating relationships between hardware and software components in a computer-operated cable lock apparatus in accordance with a preferred embodiment of the present invention;

FIG. 8 is a diagram of a dialog box used to obtain authentication information from a user of the host computer that is being used to unlock a cable lock apparatus in accordance with a preferred embodiment of the present invention;

FIG. 9 is a flowchart representation of a process of unlocking a cable lock apparatus in accordance with a preferred embodiment of the present invention;

FIG. 10 is a block diagram illustrating the electronic hardware contained within a cable lock apparatus in accordance with a preferred embodiment of the present invention; and

FIG. 11 is a block diagram of an exemplary host computer system that may be used in conjunction with a cable lock apparatus constructed in accordance with a preferred embodiment of the present invention to unlock the cable lock apparatus.

### DETAILED DESCRIPTION

The following is intended to provide a detailed description of an example of the invention and should not be taken to be limiting of the invention itself. Rather, any number of variations may fall within the scope of the invention, which is defined in the claims following the description.

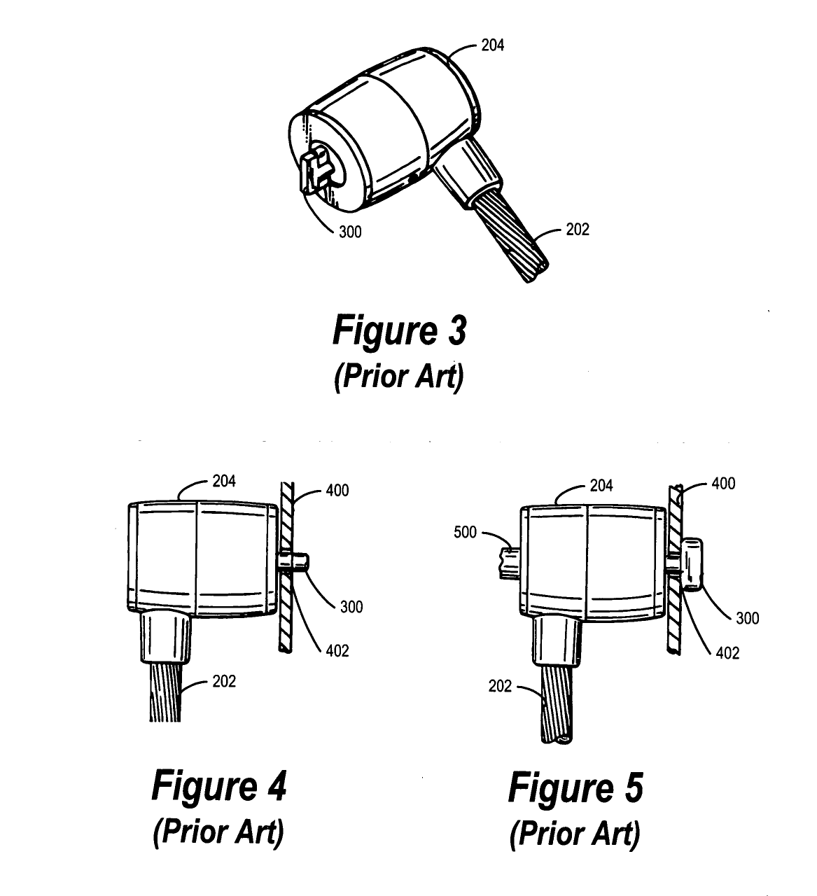

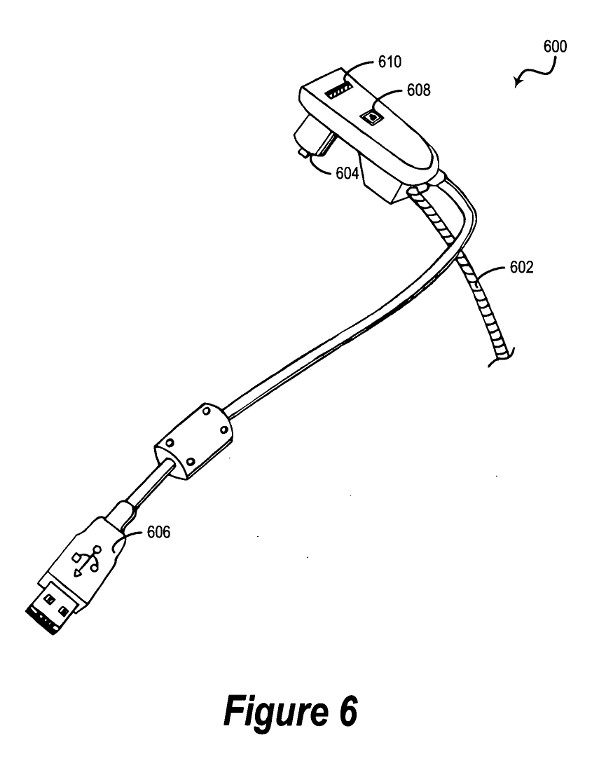

FIG. 6 is a pictorial diagram providing an external view of a cable lock device 600 in accordance with a preferred embodiment of the present invention. Cable lock device 600, like the cable lock device depicted in FIG. 2, utilizes a cable 602 that is attached to a plug 604. Plug 604 uses a similar mechanism to that depicted in FIGS. 3-5 to attach plug 604 to a hardware device, such as a mobile computer. Cable 602 is preferably affixed at one end to a stationary surface in a manner similar to the device in FIG. 2.

Cable lock device 600 has an attached USB (Universal Serial Bus) cable 606, which may be used to connect cable lock device 600 to an available USB port on a host computer system. The USB interface standard is particularly suited for use in an embodiment of the present invention, because USB devices are “hot swappable.” This means that a USB device may be connected to or disconnected from a host computer system without disrupting the operation of the host. In general, computer systems that utilize hot swappable interfaces such as USB are capable of detecting when a device has been connected. In a preferred embodiment of the present invention, the act of connecting USB cable 606 to a USB port on a running computer system is detected by the operating system of the host computer system. The operating system then causes software (such as a device driver) to execute to prompt the user to enter a password to either lock or unlock device 600 (by manipulating plug 604). Once cable lock device 600 is either locked or unlocked, as desired, USB cable 606 may be unplugged from the host computer's USB port.

In an alternative mode of operation, USB cable 606 may be left plugged into the host computer. In this alternative mode, the software that prompts the user to enter a password is executed in response to either the user's issuing a command to the host computer to execute the software or the user's actuating lock/unlock request switch 608, which is mounted on cable lock device 600. Cable lock device 600 also includes its own USB port 610. This allows cable lock device 600 to be continuously plugged into the host computer, but without sacrificing an additional USB port. USB port 610 takes the place of the USB port that is occupied by USB cable 606.

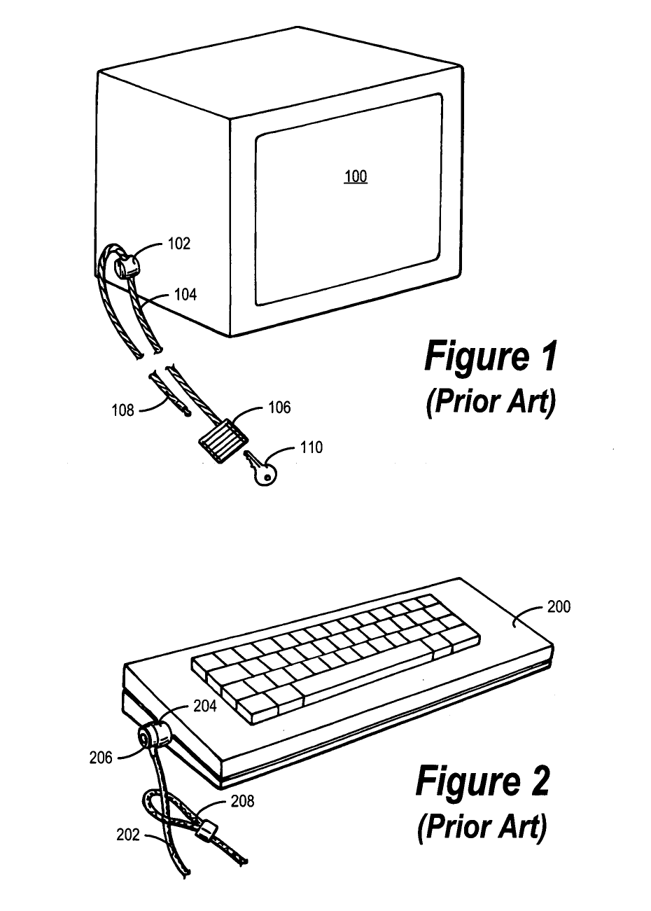

One of ordinary skill in the art will also recognize that an embodiment of the present invention may take other forms. For example, the computer-controlled, password-protected unlocking employed by cable lock device 600 may be integrated into a padlock-style cable lock device, such as that depicted in FIG. 1 (the primary difference being that in a typical padlock, one generally may lock the device simply by physically closing the padlock itself-thus, only the unlocking of the padlock need be computer-controlled). Other appropriate physical forms of the invention will be apparent to those of ordinary skill in the art and may be applied to the teachings of the present invention without departing from the scope and spirit thereof.

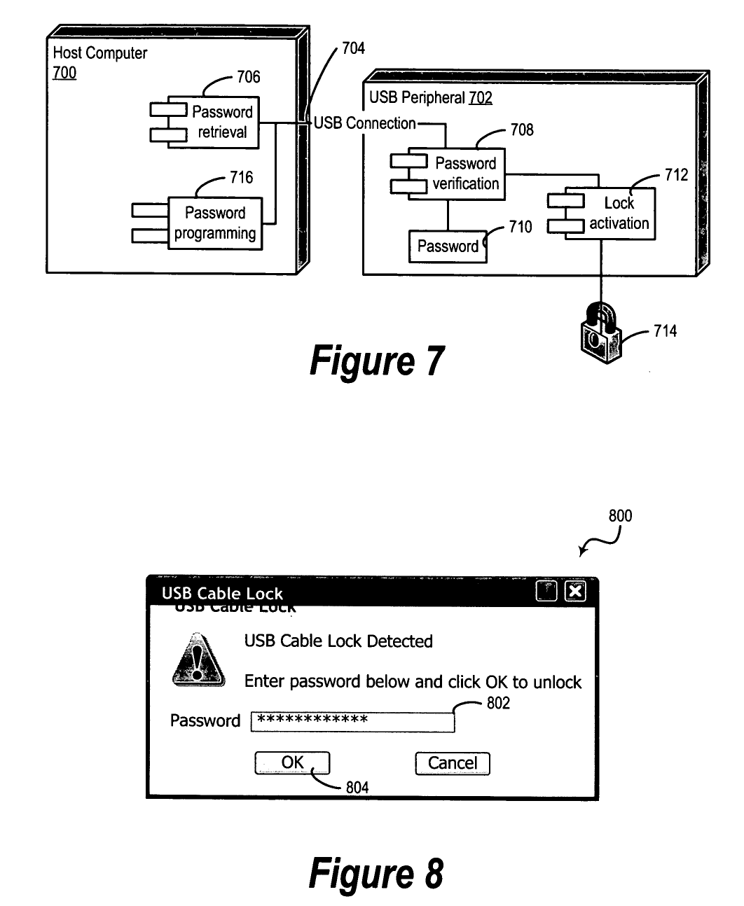

FIG. 7 is a deployment diagram illustrating relationships between hardware and software components in a computer-operated cable lock apparatus in accordance with a preferred embodiment of the present invention. The two main hardware components are a host computer 700 and a USB (Universal Serial Bus) peripheral 702. In a preferred embodiment of the present invention, USB peripheral 702 comprises electronics that are physically integrated into a cable lock device and that may be connected to a host computer system through a USB interface (e.g., USB connection 704).

One of ordinary skill in the art will recognize that embodiments of the present invention are not limited to the use of a USB interface, but may employ any of a number of computer-to-device interfaces without departing from the scope and spirit of the present invention. For example, the IEEE-1374 standard (commonly referred to in the industry as “FireWire”) is another hot-swappable interface standard that may be used instead of USB. In addition, one of ordinary skill in the art will recognize that it is also possible to construct an embodiment of the present invention using a non-hot-swappable interface. Moreover, other non-electrical interfaces, such as optical or wireless interfaces may be used in an embodiment of the present invention, without departing from the scope and spirit of the present invention. For example, some computer systems employ short-range wireless interfaces, such as the BLUETOOTH industry standard or one of the various IEEE (Institute of Electrical and Electronics Engineers) 802.11 standards for ad hoc wireless networking, for connecting a host computer to peripheral devices.

A software component 706 resides on host computer 700 and is used to obtain authenticating information from a user. In a preferred embodiment, this authenticating information is a password, although other sources of authenticating information, such as a code stored on a smart card, may be employed as well.

In this preferred embodiment, software component 706 is invoked in response to a determination that USB peripheral 702 has been connected to host computer 700 (e.g., via USB connection 704). For example, software component 706 may be contained within device driver code that is invoked by an operating system residing on host computer 700 in response to USB peripheral 702's first being physically connected to host computer 700. Component 706, once invoked, may display a message or prompt such as dialog box 800 in FIG. 8, which prompts the user to enter a password in text field 802 and click OK button 804 to unlock the cable lock. A similar dialog box may be used to enter a password to lock the cable lock.

Whatever authenticating information is received by component 706 is transmitted over USB connection 704 to USB peripheral 702, where a validation circuitry 708 validates the authenticating information received based upon additional information stored in non-volatile memory of USB peripheral 702. In this preferred embodiment, a received password is compared to a stored password 710, however, other forms of authentication/validation are well known and available to those skilled in the art and may be employed within an embodiment of the present invention without limitation and without departing from the scope and spirit thereof. The reader is directed to Chapter 10 (pp. 385-424) of MENEZES et al. Handbook of Applied Cryptography. Boca Raton, Fla.: CRC Press, 1997, ISBN 0-8493-8523-7 for a discussion of various authentication schemes known and available to those skilled in the art.

Should the authenticating information provided to USB peripheral 702 pass the validation performed by validation component 708, a lock activation software component 712 is then executed. Lock activation component 712 contains program code for activating the mechanical mechanism for unlocking the cable lock.

In a preferred embodiment, a software component 716 may be used to program USB peripheral 702 with a new password. Software component 716 may comprise a part of the operating system of host computer 700 or it may exist as a separate executable application. A user directs host computer 700 to execute software component 716, which, after authenticating the user (using existing password 710), allows the user to enter a new password to be transmitted to USB peripheral 702 over USB connection 704.

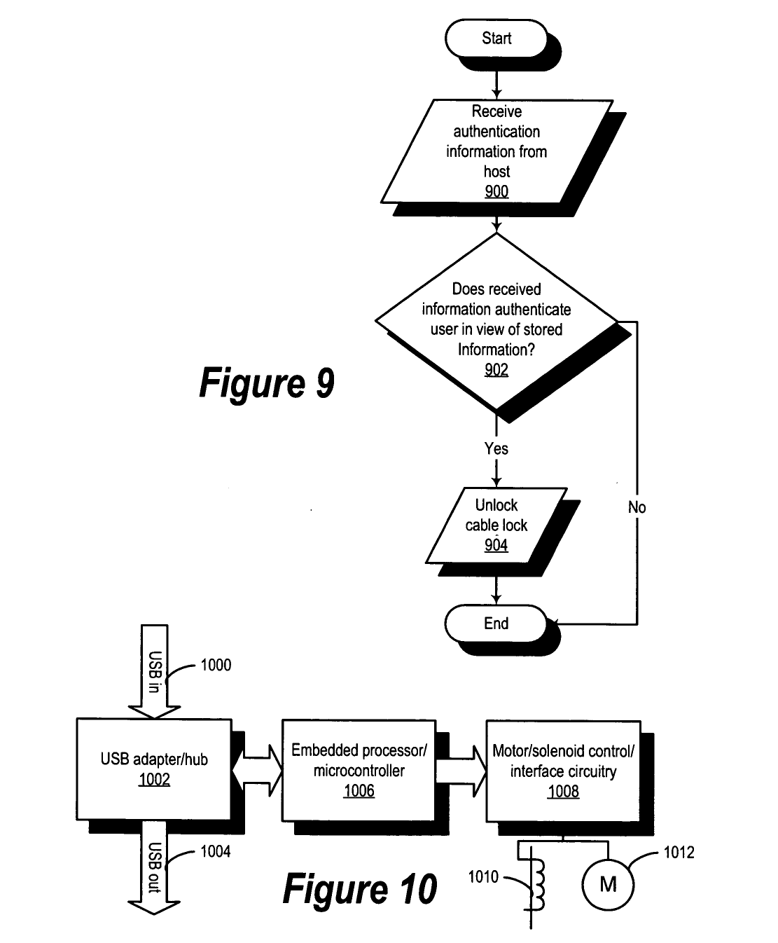

FIG. 9 is a diagram wherein a process of unlocking a cable lock in accordance with a preferred embodiment of the present invention is presented in flowchart form. The embedded electronics contained within the cable lock apparatus first receives authentication information from a host computer (block 900). A determination is then made as to whether the received information authenticates the user as someone authorized to unlock the cable lock device, as per the authenticating information stored within the cable lock apparatus (block 902). If so (block 902:Yes), additional instructions are executed that cause the lock to become unlocked (block 904), with the process terminating immediately thereafter. If the received information does not authenticate the user (block 902:No), however, the process simply terminates.

FIG. 10 is a block diagram illustrating the electronic hardware contained within a cable lock apparatus in accordance with a preferred embodiment of the present invention. A USB client device interface 1000 receives authenticating information and/or other commands or data from the host computer system. Other commands or data received from the host computer may include instructions to set or modify the password or other authentication information stored within the cable lock apparatus' electronics. USB client interface 1000 also serves as a source of power to the cable lock apparatus electronics, since the USB standard allows for a host system to supply power to external USB peripherals through the physical USB interface.

USB client interface feeds into a USB adapter/hub component 1002, which is preferably implemented either as a portion of a monolithic integrated circuit or as a separate integrated circuit (IC) itself. A number of USB adapter ICs are available from various vendors. USB adapter/hub 1002 translates the USB interface signals from client interface 1000 into signals that are compatible with embedded processor/microcontroller 1006. USB adapter/hub 1002 may also provide an additional USB host interface 1004 to allow additional USB peripherals (such as a mouse, for example) to be connected to USB adapter/hub 1002. In the manner, the cable lock device described in FIG. 9 may be connected to an available USB port on a host computer, but without reducing the number of available USB ports for use by other peripherals.

Embedded processor/microcontroller 1006 is an embedded computer system that executes software for validating authentication information and initiating the mechanical unlock procedure. The process described in FIG. 9 is carried out by software executed by embedded processor/microcontroller 1006. Embedded processor/microcontroller 1006 will, in a preferred embodiment, contain (or at least be associated with) non-volatile memory for storing both the program code executed by embedded processor/microcontroller 1006 and any authentication information (such as a password) that may be required to validate authentication information received from the host computer. One of ordinary skill in the art will recognize that although a programmable microcontroller or processor is used in this preferred embodiment of the present invention, one may utilize dedicated (“hard wired”) circuitry to perform the same functions as embedded processor/microcontroller 1006 without departing from the scope and spirit of the present invention.

Embedded processor/microcontroller 1006 is configured to activate and/or control motor/solenoid control/interface circuitry 1008. Motor/solenoid control/interface circuitry 1008 is the electrical/electronic circuitry used to activate a solenoid 1010, motor 1012, or other electromechanical device. (depending on the particular embodiment) used to mechanically unlock the cable lock itself. A solenoid, such as solenoid 1010 consists of a coiled wire within which a rod or pin constructed of a ferromagnetic material positioned. When electrical current is applied to solenoid 1010, the rod or pin is caused to retract, thus releasing the lock (this mechanism may be used in a padlock-type cable lock device, such as is depicted in FIG. 1, for example). Alternatively, an electric motor 1012 may be used to obtain rotational motion necessary to release the lock (in the case of a plug-type cable lock device as described in FIG. 2, for example).

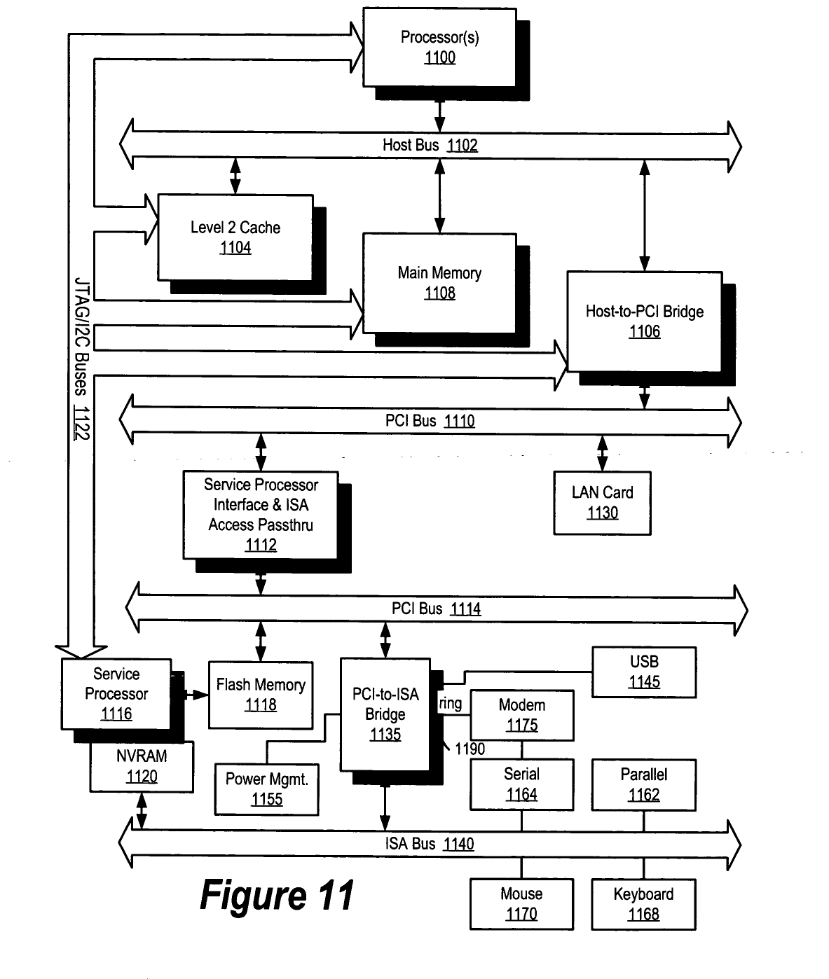

FIG. 11 is a block diagram of an exemplary host computer system that may be used in conjunction with a cable lock apparatus constructed in accordance with a preferred embodiment of the present invention to unlock the cable lock apparatus.

FIG. 11 illustrates information handling system 1101 which is a simplified example of a computer system capable of performing the computing operations of the host computer described herein with respect to a preferred embodiment of the present invention. Computer system 1101 includes processor 1100 which is coupled to host bus 1102. A level two (L2) cache memory 1104 is also coupled to host bus 1102. Host-to-PCI bridge 1106 is coupled to main memory 1108, includes cache memory and main memory control functions, and provides bus control to handle transfers among PCI bus 1110, processor 1100, L2 cache 1104, main memory 1108, and host bus 1102. Main memory 1108 is coupled to Host-to-PCI bridge 1106 as well as host bus 1102. Devices used solely by host processor(s) 1100, such as LAN card 1130, are coupled to PCI bus 1110. Service Processor Interface and ISA Access Pass-through 1112 provides an interface between PCI bus 1110 and PCI bus 1114. In this manner, PCI bus 1114 is insulated from PCI bus 1110. Devices, such as flash memory 1118, are coupled to PCI bus 1114. In one implementation, flash memory 1118 includes BIOS code that incorporates the necessary processor executable code for a variety of low-level system functions and system boot functions.

PCI bus 1114 provides an interface for a variety of devices that are shared by host processor(s) 1100 and Service Processor 1116 including, for example, flash memory 1118. PCI-to-ISA bridge 1135 provides bus control to handle transfers between PCI bus 1114 and ISA bus 1140, universal serial bus (USB) functionality 1145, power management functionality 1155, and can include other functional elements not shown, such as a real-time clock (RTC), DMA control, interrupt support, and system management bus support. Nonvolatile RAM 1120 is attached to ISA Bus 1140. Service Processor 1116 includes JTAG and I2C buses 1122 for communication with processor(s) 1100 during initialization steps. JTAG/I2C buses 1122 are also coupled to L2 cache 1104, Host-to-PCI bridge 1106, and main memory 1108 providing a communications path between the processor, the Service Processor, the L2 cache, the Host-to-PCI bridge, and the main memory. Service Processor 1116 also has access to system power resources for powering down information handling device 1101.

Peripheral devices and input/output (I/O) devices can be attached to various interfaces (e.g., parallel interface 1162, serial interface 1164, keyboard interface 1168, and mouse interface 1170 coupled to ISA bus 1140. Alternatively, many I/O devices can be accommodated by a super I/O controller (not shown) attached to ISA bus 1140.

In order to attach computer system 1101 to another computer system to copy files over a network, LAN card 1130 is coupled to PCI bus 1110. Similarly, to connect computer system 1101 to an ISP to connect to the Internet using a telephone line connection, modem 1175 is connected to serial port 1164 and PCI-to-ISA Bridge 1135.

While the computer system described in FIG. 10 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. A method comprising:
receiving authentication information from an information handling system;
validating the received authentication information with respect to information stored within non-volatile storage contained within a cable lock apparatus; and
in response to a determination that the received authentication information authenticates a user of the information handling system that is authorized to unlock the cable lock apparatus, unlocking the cable lock apparatus.

2. The method of claim 1, wherein the authentication information is a password.

3. The method of claim 1, wherein unlocking the cable lock apparatus includes releasing a padlock associated with the cable lock apparatus.

4. The method of claim 1, wherein the authentication information is received via a universal serial bus (USB) interface.

5. The method of claim 1, wherein unlocking the cable lock apparatus includes releasing the cable lock apparatus from the information handling system.

6. The method of claim 1, wherein the information handling system is selected from the group consisting of a mobile computer, a desktop computer, a personal digital assistant device, and a handheld computer.

7. A method comprising:
unlocking a cable lock apparatus, the steps for unlocking including:
establishing a connection between a computer and embedded electronics contained within the cable lock apparatus; and
providing authentication information to the computer for transmission to the embedded electronics, wherein the embedded electronics directs a mechanism within the cable lock apparatus to unlock the cable lock apparatus in response to a determination that the authentication information can be validated by the embedded electronics.

8. The method of claim 7, wherein establishing the connection includes attaching an electrical connector associated with the cable lock apparatus to the computer.

9. The method of claim 7, wherein the connection is administered according to a hot-swappable device interface specification.

10. The method of claim 9, wherein the hot-swappable device interface specification is a Universal Serial Bus (USB) interface specification.

11. A method comprising: unlocking a cable lock apparatus, the steps for unlocking including:
establishing a connection between a computer and embedded electronics contained within the cable lock apparatus, wherein the connection is established via a hot-swappable interface; and
in response to the connection being established, providing authentication information to the computer for transmission to the embedded electronics, wherein the embedded electronics directs a mechanism within the cable lock apparatus to unlock the cable lock apparatus in response to a determination that the authentication information can be validated by the embedded electronics.

12. A program product comprising:
computer operable medium having computer readable code, the computer readable code being effective to:
receive authentication information from a computer;
validate the received authentication information with respect to information stored within non-volatile storage contained within a cable lock apparatus; and
in response to a determination that the received authentication information authenticates a user of the computer that is authorized to unlock the cable lock apparatus, unlock the cable lock apparatus.

13. The program product of claim 12, wherein the authentication information is a password.

14. The program product of claim 12, wherein the code that unlocks the cable lock apparatus includes code effective to release a padlock associated with the cable lock apparatus.

15. The program product of claim 12, wherein the authentication information is received via a universal serial bus (USB) interface.

16. An apparatus comprising:
an interface, wherein the interface allows for reception of authentication data from an information handling system;
validation circuitry, wherein the validation circuitry includes an authenticator which authenticates data received through the interface and determines whether a user of the information handling system is authorized to unlock a cable lock apparatus that locks the information handling system; and
an electromechanical lock mechanism that, when directed by the validation circuitry, releases the cable lock apparatus from a locked state.

17. The apparatus of claim 16, wherein the validation circuitry includes a programmable processor.

18. The apparatus of claim 16, wherein the electromechanical lock mechanism includes a solenoid that, when activated, causes a pin to retract.

19. The apparatus of claim 16, wherein the interface is a hot-swappable interface.

20. The apparatus of claim 19, wherein the hot-swappable interface is a Universal Serial Bus (USB) interface.

21. The apparatus of claim 16, wherein the electromechanical lock mechanism rotates a rotational lock component when directed by the validation circuitry.

22. The apparatus of claim 16, wherein the interface is configured to supply power from the information handling system to power at least one of the validation circuitry and the electromechanical lock mechanism.

23. The apparatus of claim 16 further comprising:
a second interface, wherein the second interface is configured to allow an additional peripheral to be connected through the second interface and first interface to the information handling system.

24. An apparatus comprising:
a hot-swappable computer interface, wherein the hot-swappable computer interface allows for reception of authentication data from an information handling system and the hot-swappable computer interface provides power to a cable lock apparatus;
validation circuitry, wherein the validation circuitry includes an authenticator which authenticates data received through the interface and determines whether a user of the information handling system is authorized to unlock a cable lock apparatus that locks the information handling system; and
an electromechanical lock mechanism that, when directed by the validation circuitry, releases the cable lock apparatus from a locked state.

25. An apparatus comprising: an information handling system that includes:
one or more processors;
a memory accessible by the processors;
a power supply that provides power to the processors; and
a housing that stores the processors and the power supply; and
a cable lock that locks the information handling system, the cable lock including:
a computer interface, wherein the computer interface allows for reception of authentication data from the information handling system;
validation circuitry, wherein the validation circuitry includes an authenticator which authenticates data received through the interface and determines whether a user of the information handling system is authorized to unlock a cable lock apparatus that locks the information handling system; and
an electromechanical lock mechanism that, when directed by the validation circuitry, releases the cable lock from a locked state.
